(19) United States
(12) Patent Application Publication
(10) Pub. No.: US 2022/0219988 A1
(43) Pub. Date: Jul. 14, 2022

(54) SPHERICAL CARBON PARTICLES AND METHOD FOR PRODUCING SAME

(71) Applicants: Sanwa Starch Co., Ltd., Kashihara-shi, Nara (JP); GODO SHIGEN Co., Ltd., Chuo-ku, Tokyo (JP)

(72) Inventors: Mao FUJIWARA, Kashihara-shi, Nara (JP); Junichi TAKAHARA, Kashihara-shi, Nara (JP); Tatsuo KAIHO, Chuo-ku, Tokyo (JP); Shinichi KITAMURA, Sakai-shi, Osaka (JP); Yoshihiro UMETANI, Suita-shi, Osaka (JP)

(21) Appl. No.: 17/614,729

(22) PCT Filed: Jun. 2, 2020
(86) PCT No.: PCT/JP2020/021702

§ 371 Date: Nov. 29, 2021

(30) Foreign Application Priority Data
Jun. 3, 2019 (JP) 2019-103817

(51) Int. Cl. C01B 32/05; C01B 32/00

(52) U.S. Cl. CPC C01B 32/05; H01M 4/587; C01B 32/00

(57) ABSTRACT

These spherical carbon particles have a total strength xy of 50 Mpa or greater when the crushing strength of primary particles of the carbon particles is x (MPa) and the spherical particle percentage is y.

### TECHNICAL FIELD

The present invention relates to a carbon material suitable for, for example, a raw material of a negative electrode carbon material for a lithium ion secondary battery, a column filler for high pressure liquid chromatography, a pore-forming agent used for a ceramic honeycomb structure, and an abrasive, and a method for producing the carbon material.

### BACKGROUND ART

Carbon particles are widely used as a raw material for a negative electrode carbon material for a lithium ion secondary battery, a column filler for high pressure liquid chromatography, a pore-forming agent used for a ceramic honeycomb structure, and an abrasive.

Patent Literature 1 discloses a technique of carbonizing middle-grade white bran or high-grade white bran of rice to obtain a negative electrode carbon material for a lithium ion secondary battery.

Patent Literature 2 discloses a technique of using pitch or heavy oil carbide as a column filler for liquid chromatography.

Patent Literature 3 discloses a technique of using a graphite powder as a pore-forming agent for a porous ceramic honeycomb structure.

Patent Literature 4 discloses a technique of using a wood carbide as an abrasive material.

However, while a negative electrode carbon material for a lithium ion secondary battery, a column filler for high pressure liquid chromatography, a pore-forming agent used for a ceramic honeycomb structure, and a carbon material used for an abrasive are required to have high strength, conventional carbides have insufficient strength and could not withstand practical use.

Non-Patent Literature 1 discloses a technique of obtaining a carbide powder of glucose, corn starch, cellulose, or chitosan by bringing various saccharides into contact with iodine vapor for 6 hours or more to carbonize the saccharides.

However, it is known from Non-Patent Literature 1 that a carbide in which the shape of a raw material powder is maintained is obtained by using a reaction of a saccharide and iodine, but there is no description about the shape and strength of primary particles of the powder.

### CITATION LIST

### Patent Literature

PATENT LITERATURE 1: JP-A-2006-32166

PATENT LITERATURE 2: JP-A-H03-160364

PATENT LITERATURE 3: JP-A-553-121010

PATENT LITERATURE 4: JP-A-2007-246732

### Non-Patent Literature

NON-PATENT LITERATURE 1: Naoya Miyajima et al. “Carbonization yield and porosity of carbons derived from various raw saccharides after iodine treatment” Carbon (TANSO) 2016, No. 271, 10-14

### SUMMARY OF INVENTION

### Technical Problem

An object of the present invention is to provide spherical carbon particles having high strength and an industrial method for producing the spherical carbon particles.

### Solution to Problem

As a result of intensive studies, the present inventors have found that spherical carbon particles having high strength can be prepared by heat-treating raw material particles with iodine, and have accomplished the present invention.

That is, the present inventions are:

(1) spherical carbon particles having a total strength xy of 50 MPa or greater when a collapsing strength of primary particles of carbon particles is x (MPa) and a spherical particle percentage of primary particles of carbon particles is y;

(2) the spherical carbon particles according to claim 1, wherein a raw material of the spherical carbon particles is at least one selected from starch particles or amylose particles;

(3) a method for obtaining the spherical carbon particles according to (1) or (2), wherein the method comprising a step of heating raw material particles together with iodine;

(4) the method according to (3), wherein the raw material particles are at least one selected from starch particles or amylose particles;

(5) the method according to (3) or (4), wherein a heating temperature is 100 to 200° C.; and

(6) the method according to any one of (3) to (5), wherein raw material particles having a loss in weight on drying of 7% or less are used.

### Advantageous Effects of Invention

According to the present invention, it is possible to provide spherical carbon particles having high strength and an efficient industrial production method thereof.

### BRIEF DESCRIPTION OF DRAWINGS

FIG. 1 is an SEM photograph of spherical carbon particles of Example 1. The primary particles are aggregated, but can be dispersed.

FIG. 2 is an SEM photograph of three primary particles in which spherical carbon particles of Example 1 are dispersed.

FIG. 3 is an SEM photograph of carbon particles of Comparative Example 1. The primary particles have a shape in which a plurality of carbon particles are combined and then crushed. The composite cannot be separated by dispersion, and the primary particles have sharp edges due to crushing.

FIG. 4 is an SEM photograph of carbon particles of Comparative Example 2. The primary particles have sharp edges due to crushing.

FIG. 5 is a graph showing a break-up point measured by a micro compression tester.

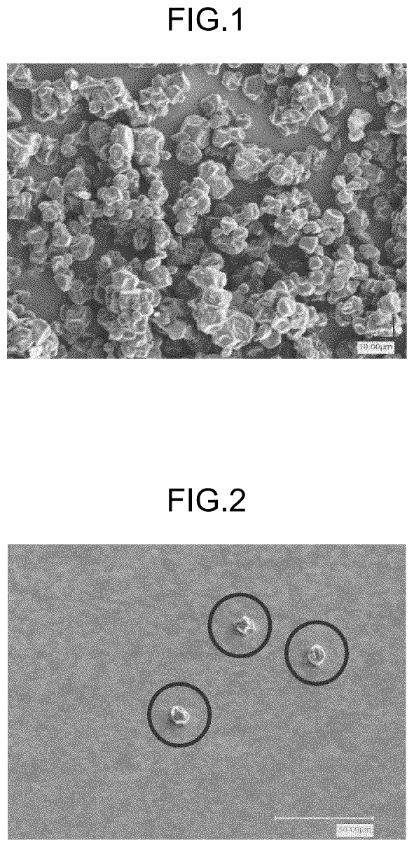

### DESCRIPTION OF EMBODIMENTS

### Primary Particle

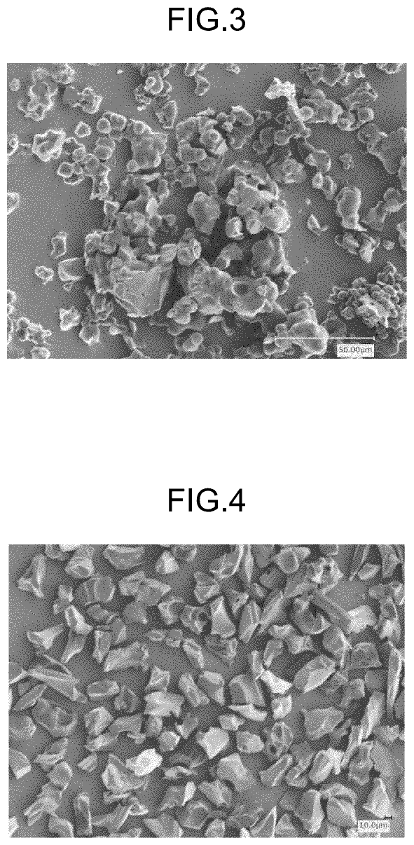

The primary particle means, for example, an independent fine particle that cannot be physically dispersed any more as shown in FIG. 2. Therefore, in the case of particles that cannot be physically dispersed any more due to the composite as shown in FIG. 3, this composite becomes a primary particle.

### Collapsing Strength x

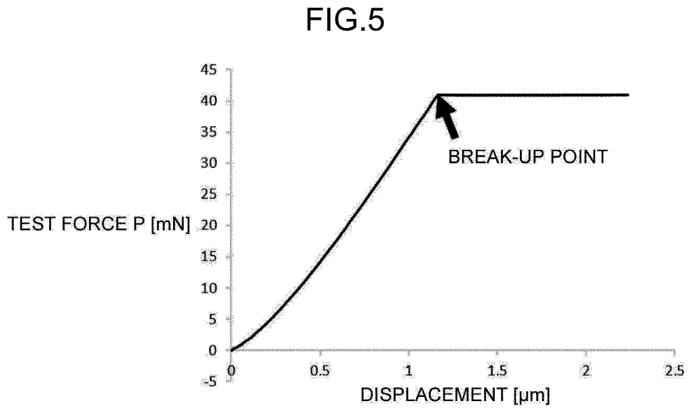

The collapsing strength in the present invention is a strength at break-up of “primary particles of carbides” (also referred to as “carbon primary particles” or “primary particles of carbon particles” in the present specification) measured by a micro compression tester, that is, a strength calculated from a test force (P) at the time of reaching the break-up point shown in FIG. 5.

First, a particle size dl of one primary particle in the vertical direction and a particle size d2 of one primary particle in the horizontal direction are measured with an attached optical microscope using a micro compression tester (trade name: MCT-510, manufactured by Shimadzu Corporation), and a particle size (d)=(d1+d2)÷2 is calculated. Then, the particle is compressed at a constant loading speed using a planar indenter at a compression testing mode of the micro compression tester, and the collapsing strength is measured. The measurement of the particle size and the collapsing strength is repeated five times per sample. The average of the obtained five collapsing strengths is defined as the collapsing strength of the sample. The break-up point refers to a point where rapid displacement occurs due to break-up as shown in FIG. 5. The loading speed is set at 1.5495 mN/sec when break-up occurs at a load of up to 98 mN, and is set at 8.2964 mN/sec when break-up occurs at a load larger than the load of 98 mN. The measurement temperature is room temperature. The particle to be measured may or may not be spherical, but is a particle having a height such that vertex of the particle is out of focus when a sample stage is focused by observation with an optical microscope.

C=2.48P/(πd²) Strength calculation formula:

C: strength (MPa), P: load (N), d: particle size (mm)

Here, the collapsing strength is a value calculated by applying the test force (P) at the time of reaching the break-up point to the above-described strength calculation formula.

The 10% compression strength is a strength calculated by applying the test force (P) at 10% displacement of the particle size measured by the micro compression tester to the strength calculation formula. In the case of particles having no break-up point as in Comparative Example 1, the collapsing strength cannot be obtained, and thus the 10% compression strength is substituted for the collapsing strength.

### Spherical Particle Percentage y

The spherical particle percentage is calculated by setting a magnification such that about 100 carbon primary particles can be confirmed in the visual field in SEM observation, and measuring the number of spherical carbon particles in randomly selected 30 carbon primary particles recognized in the field.

$$Spherical particle percentage y = number of spherical carbon particles / 30$$

### Total Strength xy

The total strength in the present invention is a value obtained by multiplying the collapsing strength x (MPa) of the carbon primary particle by the spherical particle percentage y.

### Spherical Carbon Particle

The spherical carbon particle of the present invention has a total strength of 50 MPa or greater. The total strength is preferably 200 MPa or greater, and more preferably 300 MPa or greater.

Setting the total strength to 50 MPa or greater allows suitable use of the spherical carbon particle for applications in which high pressure is applied, such as a negative electrode carbon material for a lithium ion secondary battery, a column filler for high pressure liquid chromatography, a pore-forming agent used for a ceramic honeycomb structure, and an abrasive.

The spherical shape refers to a shape that does not have a sharp edge unlike a crushed shape. The carbon material of the present invention has such a shape having no sharp edge, and thus is preferable from the viewpoint of being capable of suppressing defects due to vibration and collision with other particles. In addition, such a shape is preferable because the strength becomes high in all directions.

The spherical shape referred to herein may be a shape having no sharp edge as described above, but is preferably closer to a true sphere among shapes having no edge. Specifically, the ratio of the longest diameter to the shortest diameter when the carbon primary particle is observed from the vertical direction is preferably 1.0 to 3.0. The shape of the particle and the ratio of the longest diameter to the shortest diameter can be confirmed by observation with an optical microscope or an electron microscope.

The shape of the spherical carbon particle of the present invention is derived from a raw material, and has a feature of maintaining the shape of a raw material particle having no edge and having an aspect ratio of 1.0 to 3.0.

### Raw Material of Spherical Carbon Particle

As a raw material of the spherical carbon particle, a glucose polymer can be used, and glucose polymer particles composed of an α-1,4 glycosidic bond, an α-1,6 glycosidic bond, and a β-1,3 glycosidic bond are preferable, and glucose polymer particles composed of an α-1,4 glycosidic bond and an α-1,6 glycosidic bond are most preferable. Examples of the glucose polymer particles composed of an α-1,4 glycosidic bond and an α-1,6 glycosidic bond include starch particles and amylose particles.

### Starch

Examples of raw material starches include corn starch, waxy corn starch, high amylose corn starch, potato starch, tapioca starch, wheat starch, rice starch, sago starch, sweet potato starch, pea starch, and mung bean starch. In the present invention, starch particles that are not disintegrated by gelatinization are preferable. Further, the raw material starch may be a modified starch. The modification method is not particularly limited, and examples thereof include etherification, esterification, crosslinking, pregelatinization, oxidation, enzyme treatment, heat-moisture treatment, addition of an emulsifier, oil-and-fat processing, and processing including a combination thereof. Examples of raw material plants of starch include potatoes, sweet potatoes, corns, wheats, cassavas, rices, sago palms, peas, and mung beans. In the present invention, potatoes, corns, rices, and peas are preferable, and potatoes, corns, and rices are most preferable.

### Amylose

The raw material amylose is not amylose present in starch, but can be separated and extracted from starch and recrystallized, or can be prepared by a method known in the art by enzyme synthesis. Preferably, the raw material amylose is prepared by a known enzyme synthesis method. Examples of such an enzyme synthesis method include a method using glucan phosphorylase. Phosphorylase is an enzyme that catalyzes a phosphorolysis reaction. In the present invention, amylose particles are preferable.

### Method for Producing Spherical Carbon Particles

The spherical carbon particles having a total strength of 50 MPa or greater can be produced by heating raw material particles (preferably, starch particles or amylose particles) preferably having a loss in weight on drying of 7% or less together with iodine, preferably at a temperature range of 100 to 200° C., and then carbonizing the resulting mixture using an electric furnace under an inert gas atmosphere. When the loss in weight on drying is 7% or less, the raw material particles are not melted. In addition, by setting the heating temperature to 100° C. or higher in the presence of iodine, a dehydration reaction easily proceeds, and as a result, the strength of the obtained spherical carbon particles is increased. In addition, by setting the heating temperature to 200° C. or lower, the C═O bond cleavage is hardly occurred, so that spherical carbon particles having a total strength of 50 MPa or greater are obtained.

### Loss in Weight on Drying

The loss in weight on drying of the raw material particle is preferably 7% or less. The loss in weight on drying is more preferably 6% or less, and most preferably 3% or less. The loss in weight on drying of the raw material can be adjusted by drying or absorbing moisture of the raw material by a known method. The method for drying the raw material is not particularly limited, but for example, hot air drying, drying under reduced pressure, or lyophilization can be used, and conditions thereof can be appropriately set.

### Method of Iodine Heat Treatment

Since the heat treatment apparatus for the iodine heat treatment uses iodine having corrosiveness, it is preferable to use a material that is hardly corroded by iodine for the container. Specifically, glass, glass lining, ceramics, and bricks are preferable.

### Heating temperature of Iodine Heat Treatment

The heating temperature of the iodine heat treatment is preferably 100 to 200° C., and more preferably 130 to 190° C.

### Heating Time of Iodine Heat Treatment

The heating time of the iodine heat treatment is preferably 10 minutes to 144 hours, more preferably 10 minutes to 72 hours, and most preferably 1 hour to 24 hours.

### Application of Spherical Carbon Particles of Present Invention

The spherical carbon particles of the present invention can be suitably used as a raw material for a negative electrode carbon material for a lithium ion secondary battery, a column filler for high pressure liquid chromatography, a pore-forming agent used for a ceramic honeycomb structure, and an abrasive.

### EXAMPLES

Hereinafter, the present invention will be specifically described with reference to Examples and Comparative Examples. Note that the present invention is not limited by the following Examples in any sense.

Methods for measuring physical properties in Examples and Comparative Examples are as follows.

### 1) Loss in Weight on Drying (%)

One g of raw material particles was dried at 105° C. for 2 hours, and the weight loss of raw material particles was expressed in weight percentage.

### 2) Collapsing Strength x (MPa)

About one ear pick of carbon primary particles were scattered on a silicon carbide flat plate of a micro compression tester (trade name: MCT-510, manufactured by Shimadzu Corporation), serving as a sample stage. The particle size d1 of one carbon primary particle and the particle size d2 in the horizontal direction were measured using an attached optical microscope, and the particle size (d) was calculated from the average value of d1 and d2.

$$Particle size ( d ) = ( d 1 + d 2 ) \div 2$$

Next, the primary particle was compressed at a constant loading speed using a planar indenter at a compression testing mode of the micro compression tester, and the collapsing strength was measured by the following formula. The measurement of the particle size and the collapsing strength was repeated five times per sample, and the average of the obtained five collapsing strengths was defined as the collapsing strength of the sample. The loading speed was set at 1.5495 mN/sec when break-up occurs at a load of up to 98 mN, and was set at 8.2964 mN/sec when break-up occurs at a load larger than the load of 98 mN. The measurement temperature was room temperature.

C=2.48P/(πd²) Strength calculation formula:

C: strength (MPa), P: load (N), d: particle size (mm)

In the case of particles having no break-up point as in Comparative Example 1, the collapsing strength cannot be obtained, and thus the 10% compression strength was measured.

### 3) Spherical Particle Percentage y

In SEM observation using a microscope VHX-D510 manufactured by Keyence Corporation, a magnification was set such that about 100 carbon primary particles can be confirmed in the visual field. The number of spherical carbon particles in randomly selected 30 carbon primary particles recognized in the visual field was measured, and the spherical particle

$$Spherical particle percentage y = number of spherical carbon particles / 30$$

### 4) Total Strength xy (MPa)

The total strength xy (MPa) was calculated by multiplying the collapsing strength x (MPa) calculated in the above 2) by the spherical particle percentage y calculated in the above 3).

### Example 1

First, about 20 g of corn starch (manufactured by Sanwa Starch Co., Ltd.), whose loss in weight on drying has been adjusted to 2.7 wt % by drying at 120° C. for 30 minutes using a blowing constant temperature dryer, was charged in an eggplant flask together with 2 g of iodine. The eggplant flask was attached to a rotary evaporator opened to such an extent that iodine was kept retained in the eggplant flask. Then, a heat treatment was performed with stirring at 160° C. for 1 hour using an oil bath. Subsequently, the mixture was heated at 800° C. for 1 hour using an electric furnace under an inert gas atmosphere to obtain a particulate carbide of corn starch. This carbide was a spherical carbon particle and had a total strength of 351 MPa, which was high strength.

### Example 2

A particulate carbide of corn starch was obtained in the same manner as in Example 1 except that corn starch dried at 120° C. for 15 minutes and having a loss in weight on drying of 6.0 wt % was used as a raw material.

### Example 3

A particulate carbide of corn starch was obtained in the same manner as in Example 1 except that corn starch was heat-treated together with iodine at 190° C. for 10 minutes with stirring.

### Example 4

A particulate carbide of corn starch was obtained in the same manner as in Example 1 except that corn starch was heat-treated together with iodine at 100° C. for 144 hours with stirring.

### Example 5

About 20 g of rice starch (manufactured by Joetsu Starch Co., Ltd.) whose loss in weight on drying has been adjusted to 5.4 wt % by drying under reduced pressure at 50° C. for 4 days was charged in a porcelain crucible. The crucible was placed in a glass beaker in an oil bath, and iodine was charged in the glass beaker. This was left to stand at 150° C. for 24 hours with the glass beaker opened to such an extent that iodine was kept retained in the glass beaker, to perform a heat treatment. Subsequently, the resulting material was heated at 800° C. for 1 hour using an electric furnace under an inert gas atmosphere to obtain a particulate carbide of rice starch.

### Example 6

About 10 g of potato starch (manufactured by Kosimizu-cho Agricultural Cooperative) whose loss in weight on drying has been adjusted to 6.5 wt % by drying under reduced pressure at 55° C. for 16 hours was charged in a porcelain crucible. The crucible was placed in a glass container, and iodine was placed in the glass container. This was left to stand at 170° C. for 3 hours in a constant temperature dryer in a state in which the glass container was opened, to perform a heat treatment. Subsequently, the resulting material was heated at 800° C. for 1 hour using an electric furnace under an inert gas atmosphere to obtain a particulate carbide of potato starch.

### Example 7

A particulate carbide of amylose was obtained in the same manner as in Example 5 except that about 20 g of enzyme-synthesized amylose (manufactured by PS-Biotec Inc.) having a loss in weight on drying of 4.6 wt % was heat-treated together with iodine at 130° C. for 72 hours while being left to stand.

### Comparative Example 1

One g of corn starch (manufactured by Sanwa Starch Co., Ltd.) having a loss in weight on drying of 12.5 wt % and iodine were charged in a glass container having a volume of 200 mL, and the inside pressure of the glass container was reduced to seal the container. Then, this was left to stand at 120° C. for 6 hours to perform a heat treatment. Subsequently, the resulting material was heated at 800° C. for 1 hour using an electric furnace under an inert gas atmosphere to obtain a corn starch carbide. This carbide had a powdery appearance, but the particles thereof did not have collapsing strength, and the 10% compression strength thereof was 13 MPa. This can be said to be considerably low strength in light of the 10% compression strength of the spherical carbon particles obtained in Example 1 being 175 MPa.

### Comparative Example 2

A corn starch carbide was obtained in the same manner as in Example 1 except that the raw material was corn starch (manufactured by Sanwa Starch Co., Ltd.) having a loss in weight on drying of 3.3 wt % and that iodine was not used. Since this carbide was completely melted, it was crushed and not spherical.

### Comparative Example 3

A corn starch carbide was obtained in the same manner as in Example 1 except that corn starch was heat-treated together with iodine at 210° C. for 5 minutes with stirring. Most of this carbide was melted and had a spherical particle percentage of 0.1, which was very small.

TABLE 1

| | | Loss on drying of | | Heat treatment | Collapsing | Spherical | Total |
|---|---|---|---|---|---|---|---|
| | | raw material | Presence | temperature | strength x | particle | strength xy |
| | Raw material | [%] | of iodine | [° C.] | [MPa] | percentage y | [MPa] |
| Example 1 | Corn starch | 2.7 | Yes | 160 | 377 | 0.93 | 351 |
| Example 2 | Corn starch | 6.0 | Yes | 160 | 231 | 1 | 231 |
| Example 3 | Corn starch | 2.7 | Yes | 190 | 221 | 1 | 221 |
| Example 4 | Corn starch | 2.7 | Yes | 100 | 85 | 0.96 | 82 |
| Example 5 | Rice starch | 5.4 | Yes | 150 | 209 | 0.84 | 176 |
| Example 6 | Potato starch | 6.5 | Yes | 170 | 799 | 1 | 799 |
| Example 7 | Enzyme-synthesized | 4.6 | Yes | 130 | 255 | 1 | 255 |
| | amylose | | | | | | |
| Comparative | Corn starch | 12.5 | Yes | 120 | No break-up | 0 | 0 |
| Example 1 | | | | | point | | |
| Comparative | Corn starch | 3.3 | No | 160 | 276 | 0 | 0 |
| Example 2 | | | | | | | |
| Comparative | Corn starch | 2.7 | Yes | 210 | 417 | 0.1 | 42 |
| Example 3 | | | | | | | |

### INDUSTRIAL APPLICABILITY

The spherical carbon particles of the present invention are useful as a raw material for a negative electrode carbon material for a lithium ion secondary battery, a column filler for high pressure liquid chromatography, a pore-forming agent used for a ceramic honeycomb structure, and an abrasive.

1. Spherical carbon particles having a total strength xy of 50 Mpa or greater, wherein a collapsing strength of primary particles of carbon particles is x (MPa) and a spherical particle percentage of primary particles of carbon particles is y.

2. The spherical carbon particles according to claim 1, wherein a raw material of the spherical carbon particles is at least one selected from starch particles and amylose particles.

3. A method for obtaining the spherical carbon particles according to claim 1, comprising a step of heating raw material particles together with iodine.

4. The method according to claim 3, wherein the raw material particles are at least one selected from starch particles and amylose particles.

5. The method according to claim 3, wherein the heating step comprises a heating temperature of 100 to 200° C.

6. The method according to claim 3, wherein raw material particles having a loss in weight on drying of 7% or less are used.

7. A method for obtaining the spherical carbon particles according to claim 2, comprising a step of heating raw material particles together with iodine.

8. The method according to claim 7, wherein the raw material particles are at least one selected from starch particles and amylose particles.

9. The method according to claim 4, wherein the heating step comprises a heating temperature of 100 to 200° C.

10. The method according to claim 7, wherein the heating step comprises a heating temperature of 100 to 200° C.

11. The method according to claim 8, wherein the heating step comprises a heating temperature of 100 to 200° C.

12. The method according to claim 4, wherein raw material particles having a loss in weight on drying of 7% or less are used.

13. The method according to claim 5, wherein raw material particles having a loss in weight on drying of 7% or less are used.

14. The method according to claim 7, wherein raw material particles having a loss in weight on drying of 7% or less are used.

15. The method according to claim 8, wherein raw material particles having a loss in weight on drying of 7% or less are used.

16. The method according to claim 9, wherein raw material particles having a loss in weight on drying of 7% or less are used.

17. The method according to claim 10, wherein raw material particles having a loss in weight on drying of 7% or less are used.

18. The method according to claim 11, wherein raw material particles having a loss in weight on drying of 7% or less are used.
